(19) United States
(12) Patent Application Publication
(10) Pub. No.: US 2026/0230319 A1
(43) Pub. Date: Aug. 6, 2026

(54) SECURE RECOVERY FOR MULTIOWNED COMPUTING ENVIRONMENT

(71) Applicant: Robert Bosch GmbH, Stuttgart (DE)

(72) Inventors: Shalabh JAIN, Pittsburgh, PA (US); Sven TRIEFLINGER, Renningen (DE); Pradeep M. PAPPACHAN, Pittsburgh, PA (US); Sebastian BECKER, Ludwigsburg (DE)

(21) Appl. No.: 19/043,845

(22) Filed: Feb. 3, 2025

(51) Int. Cl. H04L 9/08; H04L 9/14

(52) U.S. Cl. CPC H04L 9/0894; H04L 9/085; H04L 9/0869; H04L 9/14

(57) ABSTRACT

A method for performing secure recovery for a multi-owned computing environment (MOCE) includes establishing a confidential computing system using a trusted execution environment (TEE) associated with a plurality of participating parties (PPs), executing, on the confidential computing system, a controller in the TEE (CTEE), using the CTEE to generate a master key, generating respective master key shares corresponding to respective PPs of the plurality of PPs and providing the respective master key shares to the respective PPs, using the CTEE to generate a second key, encrypting a state corresponding to at least one of the CTEE and the MOCE with the second key and storing the state on an external system, encrypting the second key with the master key and storing the second key on the external system, and using the respective master key shares to reconstruct the master key and recovering the system state using the reconstructed master key.

### TECHNICAL FIELD

The present disclosure relates to multi-party or multi-owned computing environments.

### BACKGROUND

Various collaborative processes (e.g., digital cleanrooms, collaborative learning for AI, etc.) involve multiple entities/parties. In one example, distributed software integrations and build processes may involve multiple entities/parties independently developing and testing respective portions (e.g., software modules) of a software application and then integrating the various software modules to build the application within a computing environment (e.g., as implemented in a cloud computing system). For example, in the automotive industry, original equipment manufacturers (OEMs) and suppliers may collaborate to develop software applications that are executed on embedded systems inside vehicles. This model of collaboration may include each entity separately developing and testing some portion of the software application to defined specifications (e.g., respective requirements, application program interface (API) specifications, etc.) and eventually integrating the various software portions before final testing and implementation. In some examples, a computing environment is configured to be set up and operated by a single party or entity with full administrative power.

### SUMMARY

A method for performing secure recovery for a multi-owned computing environment (MOCE) includes, using one or more computing devices, establishing a confidential computing system using a trusted execution environment (TEE) associated with a plurality of participating parties (PPs), the confidential computing system including the MOCE, executing, on the confidential computing system, a controller in the TEE (CTEE), using the CTEE to generate a master key, generating respective master key shares corresponding to respective PPs of the plurality of PPs and providing the respective master key shares to the respective PPs, using the CTEE to generate a second key, encrypting a system state corresponding to at least one of the CTEE and the MOCE with the second key and storing the system state on an external system, encrypting the second key with the master key and storing the second key on the external system, and using the respective master key shares to reconstruct the master key and recovering the system state using the reconstructed master key.

Other embodiments include systems, one or more processors or processing devices, or other circuitry configured to implement functions corresponding to the principles of the present disclosure.

### BRIEF DESCRIPTION OF THE DRAWINGS

FIG. 1 illustrates an example cooperative computing environment.

FIG. 2 illustrates an example cooperative computing environment including a management gateway.

FIG. 3 illustrates an example confidential computing system configured to perform secure recovery according to the systems and methods of the present disclosure.

FIG. 4 is a block diagram of an example computing device configured to implement functions of the systems and methods of the present disclosure.

FIG. 5 illustrates steps of an example method for performing secure recovery in a confidential computing environment according to the principles of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In some examples, a computing environment is configured to be set up and operated by a single party or entity with full administrative power. If such an environment is used in collaborative or cooperative settings in which multiple entities contribute potentially sensitive or valuable digital assets (e.g., data, algorithms) to the overall system, the power of that single party to change the environment at any time in any way is problematic. For example, collaborating entities may not trust each other with respective intellectual property (IP), an entity with administrative power may now know assets (e.g., intellectual property) of other entities, etc. One established method for resolving this issue is to delegate the setup and operation of the computing environment (CE) to a trusted (third) party (TP). Trust extended to the TP is based on an assumption that the TP does not have interest in the digital assets that would create an incentive to extract or modify the digital assets, or the TP may be bound by various contracts or agreements not to disclose assets or other information. Further, capability of the TP to operate the environment in a secure way to prevent internal and external security threats is assumed.

FIG. 1 illustrates an example cooperative computing environment (CE) 100. For example, the CE 100 includes a computing system 104 (e.g., a computing environment implemented in a cloud computing system, one or more servers or distributed computing devices, a computing cluster, etc.) accessible by multiple entities that are users or providers of digital assets within the CE 100, which, in some examples, may correspond to developer entities 108. The entities 108 may independently develop and test respective portions (e.g., workloads 112) of a software application within the computing system 104.

If one or more of the entities 108 contribute potentially sensitive or valuable digital assets to the computing system 104, it may not be desirable for any one of the entities 108 to control the CE 100. Accordingly, in some examples, the CE 100 is configured to be set up and operated by a single party or entity with full administrative access. For example a trusted third party (TP) 116 may be assigned full administrative privilege, which may include access to a policy engine 120 configured to control setup of the computing system 104, changes to the computing system 104 subsequent to setup, etc. In some examples, the trusted TP 116 may be one of the entities 108. However, trust extended to the TP 116 is based on an assumption that the TP 116 does not have interest in the digital assets that would create an incentive to extract or modify the digital assets. Further, capability of the TP 116 to operate the CE 100 in a secure way to prevent internal and external security threats must be assumed by the entities 108.

In some examples, advanced privacy-preserving computing techniques are used to establish a confidential CE (CCE) that provides a consensus-based setup and management mechanism for the CE that performs a management operation only if all contributing entities agree. These systems replace the trust-based operations model for multi-party CEs with a model that technically enforces the rules of cooperation within the CE and allows auditing of the enforcement process. Example systems and methods for establishing a confidential CE in this manner are described in more detail in U.S. patent application Ser. No. 18/594,777, filed 4 Mar. 2024, the entire contents of which are incorporated herein by reference.

For example, a mechanism is provided for setting up and operating a multi-owned computing environment (MOCE) (e.g., a CE that is set up and operated under the governance of more than one party/entity). The MOCE includes an interface for admitting the execution of management operations of a cluster (e.g., one or more build servers, computing devices, etc. used by multiple parties to implement a software build) only if a consensus among the owners of the environment is reached that an operation is permitted. Integrated policy engines implement versatile and flexible operation management (e.g., to define which operations can be performed and by which entities, in which circumstances, etc.). A sandboxing mechanism for workloads of the respective entities is executed within the MOCE and allows for tight control over what a workload is permitted to do (e.g., accessing other digital assets, opening network connections, etc.), and which resources the workload is permitted to consume (e.g., main memory, CPU/GPU time, etc.). The MOCE may further include a tamper-proof auditing mechanism to track which management operations have been performed by which entities (and when the management operations were performed) and a backup and recovery mechanism.

As used herein and described below in more detail, “CMI” refers to a consensus-driven management interface. “Participating party” (PP) refers to a party participating in a collaboration enabled by the principles of the present disclosure on the CE. The terms “party” and “entity” may be used interchangeably. A “computing environment” (CE) refers to the environment used by the PPs for collaboration, such as on a software build. Although described with respect to a collaboration for a software build, in other examples the principles of the present disclosure may be implemented for other types of collaborative CEs. A “hosting party (HP) refers to the party that instantiates the CE on its own or third-party infrastructure. “Trusted execution environment (TEE) refers to one example environment that is secure in accordance with confidential computing techniques that implement hardware protection techniques. A TEE provides the ability to establish trust in the TEE by a process called remote attestation (RA). A controller TEE is a TEE that hosts the control logic implementing the CMI and performs the management actions on the CE when consensus is reached. A controller TEE is implemented using one or more computing devices, processors or processing devices, etc. “Multi-party computation (MPC) refers to a form of secure computation where the function to be computed is distributed over non-colluding entities.

Computing environments according to the present disclosure are configured to implement a consensus-driven management interface (CMI or CMMI) or consensus-driven management API (CAPI). A CMI or CAPI according to the present disclosure is an interface over which PPs can make a proposal or request for invoking a management functionality exposed over the interface. In an example embodiment, to set up the CE, the hosting party (HP) launches a TEE, referred to herein as the controller TEE (CTEE, or “controller in a trusted execution environment”), on a computing device or platform configured to provide the required confidential computing support. The computing device can be a public cloud provider, an on-premises datacenter (e.g., local to one or more of the entities), or combinations thereof. The CMI is implemented via a CTEE, which may be referred to as a management gateway.

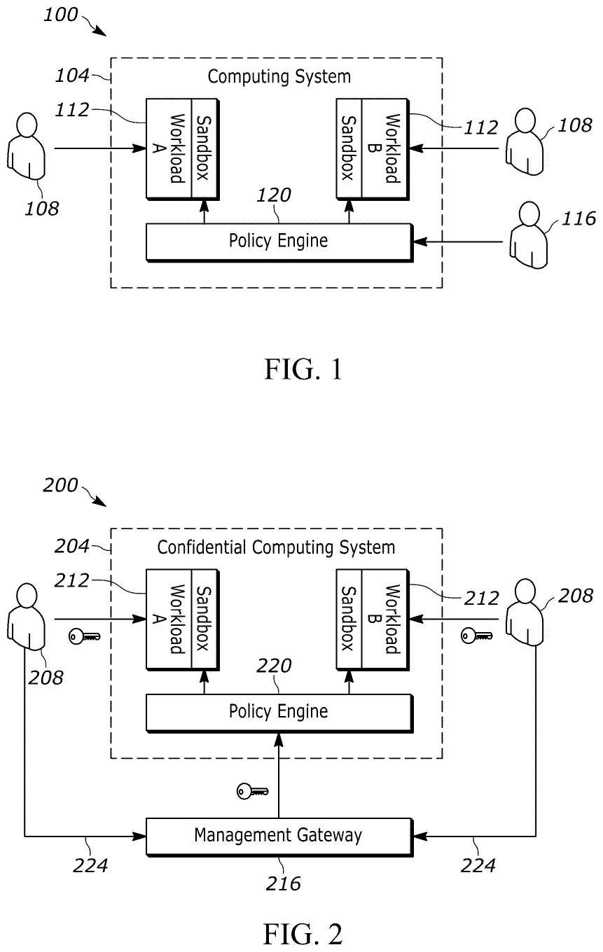

FIG. 2 illustrates an example cooperative computing environment (CE) 200 configured to implement a CMI. For example, the CE 200 includes a confidential computing system 204 (e.g., a computing environment implemented in a cloud computing system, one or more servers or distributed computing devices, a computing cluster, etc.) accessible by multiple developer entities (e.g., PPs, client computing devices, etc.) 208. The entities 208 may independently develop and test respective portions (e.g., workloads 212) of a software application within the computing system 204. In an example, the computing system 204 implements or is implemented by a confidential Kubernetes (K8s) cluster.

The CE 200 is configured to remove the need for a trusted TP by using advanced privacy-preserving computing techniques to establish an interface to the CE 200 that provides a consensus-based setup and management mechanism for the CE 200 that performs a management operation only if all contributing entities agree.

For example, the CE 200 is configured to implement a trusted, consensus-based management gateway 216. In an example, the management gateway 216 is configured to implement and/or operate in accordance with a TEE (e.g. a controller TEE, or CTEE). The management gateway 216 is used to set up and operate the CE 200 (e.g., via management and control of policy engine 220). The computing system 204 is further configured to implement other components of the systems and methods described above, such as the operating system, controller software module, etc.

The management gateway 216 is configured to function as an interface for admitting the execution of management operations in the computing system 204 only if a consensus among the entities 208 is reached that an operation is permitted. In some examples, “consensus” may require agreement from all entities. In other examples, consensus may be achieved by agreement from a subset of all entities (e.g., a number of entities less than a total number of the entities), by reaching a threshold value (e.g., a threshold value corresponding to a combination of weighted votes or values from respective entities), etc. For example, the management gateway 216 (in communication with and responsive to the controller software module implemented on/by the computing system 204) is configured to implement all or portions of the CMI or CAPI described herein. Although shown separate from the computing system 204 (e.g., “off-cluster”), in other examples the management gateway 216 may be integrated with (e.g., located within) the computing system 204.

Accordingly, the management gateway 216 is configured to provide an interface over which the entities 208 can make a proposal or request for invoking a management functionality (e.g., via respective control paths 224). For example, any proposals or requests are provided from the entities 208 to the management gateway 216 and kept in a pending state until all (or a defined subset) of the entities 208 have approved the proposal in accordance with the systems and methods described herein.

In confidential computing systems such as the CE 200, management and access to potentially highly sensitive data stored in the CE 200 (e.g., by individual services deployed in the CE 200, users with access to the CE 200, etc.) may be strictly regulated and changes to the CE 200 may be prevented without consensus among the PPs as described above. Further, typical applications implemented using an MOCE require high availability and the ability to recover the computing environment in case of catastrophic system failure. While most systems that form the underlying basis for a MOCE (e.g., a Kubernetes cluster) implement recovery techniques for system recovery, ensuring security of recovery mechanisms as well as ensuring that recovery operations are an extension of existing consensus-based mechanisms is desirable.

Secure recovery systems and methods according to the present disclosure are configured to use the consensus mechanism of a CE (e.g., a CTEE) to implement/execute recovery of the MOCE/CTEE as described below in more detail. For example, the CTEE is configured to provide a consensus-driven setup and management mechanism for the CE such that management operations are performed only if a quorum of collaborating parties (e.g., a simple majority or other predetermined number of the PPs, all of the PPs, etc.) agree.

The systems and methods described herein may be implemented for secure recovery of, generally, MOCEs, as well as CTEEs. For example, respective states of the MOCE and CTEE can be backed up periodically (e.g., at a pre-determined frequency) and maintained in an encrypted state outside of the MOCE/CTEE. Upon failure, a quorum of PPs can reconstruct required keys to recover the CTEE and the MOCE to a known state. In an example CE described below, a secure recovery system includes one or more recovery modules configured to create cryptographic keys to protect the state of the MOCE and/or the CTEE. One or more persistent storage modules (e.g. block storage modules), which may be implemented outside of (external to) the MOCE/CTEE, are configured to store respective states of the MOCE and the CTEE. For example, a single storage module may store the states of both the MOCE and the CTEE. As another example, states of the MOCE and the CTEE may be stored in different storage modules. Respective portions of recovered material of the MOCE may be independently shared with/distributed to corresponding PPs.

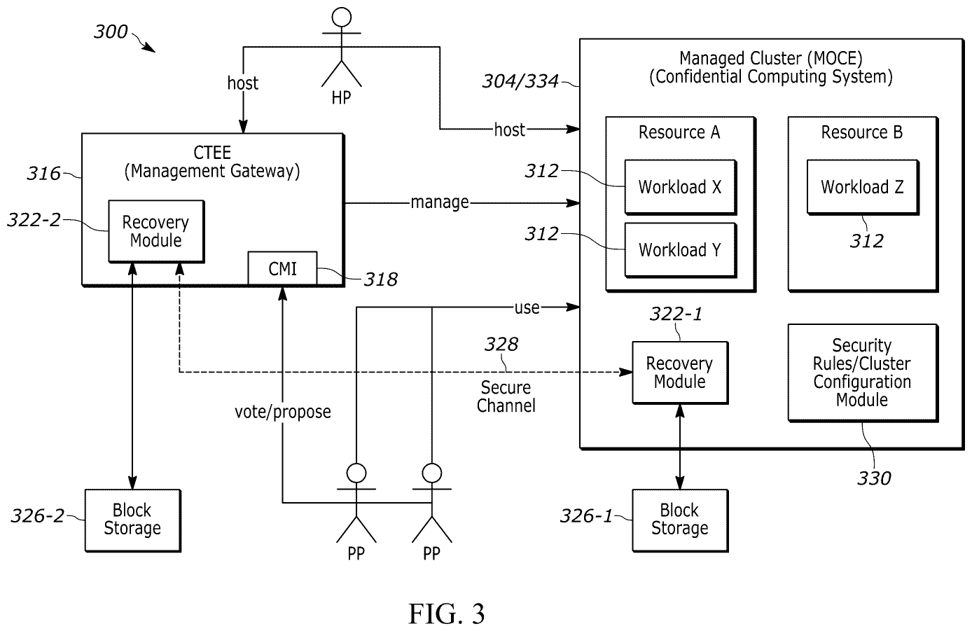

FIG. 3 illustrates an example CE 300 configured to implement secure recovery techniques according to the principles of the present disclosure. The CE 300 may be generally configured in a manner similar to the CE 200 of FIG. 2. Some elements shown in FIG. 2 are omitted from FIGS. 3A and 3B for simplicity. For example, the CE 300 includes a confidential computing system/MOCE 304 accessible by multiple developer entities (e.g., PPs, client computing devices, etc.). For example, different portions (e.g., workloads 312 associated with respective resources A, B, etc.) of a software application within the computing system 304 may be independently accessed by respective entities for developing and testing. In an example, the MOCE 304 implements or is implemented by a confidential Kubernetes (K8s) cluster. Accordingly, the MOCE 304 may be referred to as an MOCE, and the terms “computing system” and “MOCE” may be used interchangeable in the context of the system 304.

The CE 300 includes a CTEE 316 configured to host/execute control logic for implementing a CMI 318. In some contexts, functionality of the CTEE 316 may be referred to as a management gateway (e.g., a trusted, consensus-based management gateway configured to implement and/or operate in accordance with a TEE).

The CE 300 according to the present disclosure is configured to implement secure recovery systems and methods to recover respective states, configuration information, etc. of the MOCE 304 and/or the CTEE 316. Changes to the CE 300 relative to the CE 200 may include, but are not limited to: changes to initialization procedures for the MOCE 304 and the CTEE 316; updates to synchronize internal states of the MOCE 304 and the CTEE 316 with persistent storage; implementation of a consensus-based recovery mechanism using the internal states in persistent storage; and distribution of recovery shares and updates during member addition and deletion.

For example, the 304 may implement all or portions of a recovery module 322-1 as described below in more detail. Similarly, the CTEE 316 may implement all or portions of a recovery module 322-2. The recovery modules 322-1 and 322-2 may be referred to collectively as recovery modules 322. The recovery modules 322 are configured to store information indicating respective states of the MOCE 304 and the CTEE 316 in respective block storage devices or modules 326-1 and 326-2, referred to collectively as block storage modules 326. Although shown as separate components, the block storage modules 326 may be combined into a single storage module or location. The block storage modules 326 may correspond to storage locations external to/remotely located from the MOCE 304 and the CE 300, such as storage provide by remote servers, cloud computing or other distributed computing systems, etc.

To implement secure recovery techniques according to the present disclosure, the CE 300 is configured to perform initialization of key material (e.g., during initialization/initial setup of the CE 300) as described below. For example, upon initialization of the CTEE 316 by the HP, the recovery module 322-2 initializes a CTEE master key

$$( {K}_{m}^{CTEE} )$$

by querying a random number generator (RNG) within the CE 300 to obtain a cryptographic key of sufficient length (e.g., 256-bit key). The master key is unique for a set of PPs and a time period. In case of a change in the PPs of the consensus, a new master key can be generated for the CTEE 316.

In an example, the master key is never exported outside the CTEE 316 in a plain (e.g., unencrypted) state. The recovery module 322-2 generates shares/portions of the master key in accordance with the consensus mechanism used by the CTEE 316 (e.g., using various secret sharing techniques). In other words, each PP receives a different share/portion corresponding to the master key. As one example, for a system with n parties using a consensus mechanism where every participant must agree to a management operation, the CTEE 316 can generate each share/portion of the master key

$${K}_{m}^{CTEE}$$

by selecting a number of random values (e.g., n−1 random values s₁, s₂ . . . , sₙ₋₁), and generating

$${s}_{n} = {K}_{m}^{CTEE} ⊕ {s}_{1} ⊕ {s}_{2} ⊕ … ⊕ {s}_{n - 1} ,$$

where sᵢ represents an a share of the secret key distributed to the ith PP. Alternative example techniques (e.g., Shamir secret sharing) may allow the keys to be shared between PPs such that a predetermined threshold number of participants can generate the key.

For encryption of a state of the CTEE 316, a state encryption key of sufficient length (e.g., 256-bits),

$$( {K}_{s}^{CTEE} ) ,$$

is generated (e.g., using the system RNG). The state encryption key can be used to encrypt any configuration information required to restore the state of the MOCE 304. In an example, the state encryption key is encrypted using the master key (e.g., by obtaining respective shares of the master key from the PPs) and symmetric encryption algorithms (e.g., advanced encryption standards, or AES) and stored in persistent storage (e.g., the block storage module 326-2) along with information about the consensus mechanism used to generate the master key shares.

For encryption of MOCE related information held by the CTEE 316, a 256-bit cluster encryption key

$$( {K}_{c}^{CTEE} )$$

is generated (e.g., using the system RNG). Similar to the handling of the state encryption key

$${K}_{s}^{CTEE}$$

described above, the cluster encryption key is stored in persistent storage after encryption with the master key.

For protecting the integrity of the system state, a public-private key pair

$$( {PK}_{i}^{CTEE} , {SK}_{i}^{CTEE} )$$

can be generated. A certificate for the key-pair is generated/rooted in a system attestation procedure supported by confidential computing hardware of the CTEE 316. The certificate can be used to demonstrate that the operation resulting in the key pair occurred inside the confidential computing environment of the CTEE 316 running a software stack with an established secure measurement technique (e.g., a hash of the code stored in memory). Accordingly, the generated secret key is not transmitted outside of a protection boundary of the CTEE 316 and the public key, along with the generated certificate, is stored in the persistent storage of the block storage module 326-2.

In some examples, the same key may be used as both the cluster encryption key and the state encryption key. Additionally, the usage of 256-bit keys only one provided example. The keys may be of any length that provides sufficient security against known attacks during time of system implementation.

Similar to initialization of the CTEE 316, when the MOCE 304 is initialized by the CTEE 316, the recovery module 322-1 in the MOCE 304 generates an MOCE master key

$$( {K}_{m}^{MOCE} )$$

and an MOCE state key

$$( {K}_{s}^{MOCE} )$$

in a similar manner as that of the keys for the CTEE 316. However, a public-private key pair may not be required for MOCE recovery.

The MOCE master key

$$( {K}_{m}^{MOCE} )$$

can be transferred to the recovery module 322-2 of the CTEE 316 using a secure channel or connection 328 between the CTEE 316 and the MOCE 304 (e.g., between the respective recovery modules 322). Upon receiving the MOCE master key, the recovery module 322-2 of the CTEE 316 encrypts the MOCE master key with the cluster encryption key and stores the encrypted MOCE master key in the persistent storage maintained by the CTEE 316 (e.g., the block storage module 326-2). The MOCE state key is encrypted by the MOCE master key and stored in persistent storage maintained by the MOCE 304 (e.g., the block storage module 326-1).

In some examples, a system used for implementation of the MOCE 304 and/or the CTEE 316 architecture may have an existing recovery architecture and corresponding key hierarchy. In such a case, the key structure and usage described above may be substituted by a native key hierarchy of the system and the key usage as required for system recovery. However, the underlying system must allow management of a master key (or a key at the root of the key hierarchy, such as a root key) by an external entity. Accordingly, the MOCE system must allow the master key to be managed within the CTEE 316 and the CTEE 316 must allow for management of the key by the users.

To implement secure recovery techniques according to the present disclosure, the CE 300 is configured to perform periodic synchronization of system states as described below. For example, to ensure recoverability, system information, such as a system configuration, required to restore a state of the system must be periodically stored in persistent storage (e.g., the block storage modules 326). The system configuration can be represented as a pre-defined data structure or simply stored as a key-value store. For the CTEE 316, the system information may include information such as attributes of the PPs, actions proposed by the PPs and results of the actions, logs, native attributes of the CE 300, topology information (e.g., in examples where the CTEE 316 is comprised of distributed nodes), etc. Additional attributes specific to the CTEE 316 can be stored in a state data structure. The state information may exclude ephemeral data or actions that have not yet reached a full consensus.

At predetermined time intervals, T, the recovery module 322-2 of the CTEE 316 creates a new snapshot of the state data structure, encrypts the snapshot, and performs integrity protection for the encrypted snapshot with the state key

$${K}_{s}^{CTEE}$$

(e.g., using a technique such as AES-GCM (Galois/counter mode)). The encrypted data and signature is stored in the block storage module 326-2. Within the state data structure, basic attributes of the PPs (e.g., participant IDs and known PKI certificates) can be stored without encryption. An integrity measurement of the PPs and certificates is obtained by generating a signature over the participant data using the secret key

$${SK}_{i}^{CTEE} .$$

Further, binding between the encrypted state data and participant list is created by storing reference to the participant list in the form of a hash computed over the list, within the data structure. The participant list, the signature, and the computed hash are stored within the data structure. Of these elements, only the hash value may be included in the encryption and integrity protection of the state data using the state key.

Further, after each operation requested by a PP resulting in a consensus or change in the system state, the recovery module 322-2 updates the encrypted state data structure in the block storage module 326-2.

Similar to the CTEE 316, the recovery module 322-1 of the MOCE 304 creates periodic encrypted snapshots of the MOCE system state on persistent storage (e.g., the block storage module 326-1, protected and integrity protected by the state key

$${K}_{s}^{MOCE} .$$

The MOCE state may include, as shown schematically at 330, configuration information, security access rules, services running in the MOCE 304 and connectivity information for the services, local secrets stored by the PPs in the MOCE 304, etc. Additional attributes specific to the MOCE information can be stored in the state data structure.

A system used for implementation of the MOCE 304 and/or the CTEE 316 architecture may have an existing definition of required system state and mechanisms to store in persistent storage. Such mechanisms in the underlying system can be used directly by the MOCE 304 and/or the CTEE 316, ensuring that the keys used to store the persistent state are protected by the master key, or can be derived from the master key.

To implement secure recovery techniques according to the present disclosure, the CE 300 is configured to implement a consensus-based recovery mechanism as described below. For example, a failure of the MOCE 304 may be detected by the CTEE 316 during operations. Upon a catastrophic failure of the MOCE 304, the CTEE 316 can change to a state (e.g., to a MOCE-DOWN state) indicating to the PPs that MOCE recovery needs to be performed. In response to the nodes (e.g., the PPs, via a consensus mechanism) selecting an option to recover the MOCE 304 (e.g., instead of instantiating a new MOCE), recovery of the MOCE 304 proceeds as follows in one example recovery process:
At least one of the PPs uses the CMI 318 to trigger the recovery of the MOCE 304;
All (or a required quorum) of the PPs examine the proposal and vote to accept or reject the proposal. In case of rejection, the CTEE 316 remains in the MOCE-DOWN state;
Upon acceptance of the proposal by a quorum or all of the PPs, the CTEE 316 launches a new MOCE 334 and attaches MOCE recovery persistent storage (i.e., the block storage modules 326 containing the stored configuration information, states, etc. of the MOCE 304) to the new MOCE 334;

The CTEE 316 injects the MOCE master key,

$${K}_{s}^{MOCE}$$

into the recovery module 322-1 of the MOCE 304 over the secure channel 328 established between the CTEE 316 and the MOCE 304;
The recovery module 322-1 of the MOCE 304 uses the master key to validate the integrity of the stored recovery information, decrypt the state information and load the state information into a new instance (i.e., as the new MOCE 334);
Upon successful completion of the loading of the state information, the recovery module 322-1 of the MOCE 304 pushes the state of the MOCE 304 to the recovery module 322-2 of the CTEE 316. In case of failure, the recovery module 322-2 of the CTEE 316 can initiate a reset of the MOCE 304 to an uninitialized state; and
The recovery module 322-2 of the CTEE 316 updates the state of the CTEE 316 to a regular/normal operating state. The PPs can query the state and proceed with the operations as required using the new MOCE 334.

The HP monitors the status/state of the CTEE 316 periodically to detect any failures. Upon a catastrophic failure of the CTEE 316, the HP can terminate the existing CTEE instance while preserving the persistent storage disk (i.e., the block storage module 326-2). Recovery of the CTEE 316 proceeds as follows in one example recovery process:
The HP launches a new CTEE instance with the same parameters as the original instance of the CTEE 316;
The HP validates the integrity of the participant list by using the stored public key and signature and sets the initial PPs to correspond to the stored list;
The HP sets a recoverable flag on the new CTEE instance and sets the state of the new CTEE instance as uninitialized;
A PP can query the recoverable flag over the CMI 318 to validate the availability of a recovery disk. Any PP can initiate the CTEE recovery mechanism through a request over the CMI 318. The CTEE proposal created as a result of the request indicates the required consensus mechanism for recovery of the master key;
A node/PP voting to accept the CTEE proposal provides a corresponding share of the master key to the CTEE 316, whish is transferred to the recovery module 322-2. Once a quorum of PPs, as required for the master key reconstruction, vote affirmatively, the recovery module 322-2 can reconstruct the master key from the corresponding shares;
The recovery module 322-2 validates the integrity of the recovery information and initiates an update of the CTEE state based on the state information. In case of failure, the recovery module 322-2 can initiate a reset of the CTEE 316 to an uninitialized state; and
Upon successful recovery, the recovery module 322-2 updates the CTEE state to a regular/normal operating state. The PPs can query the state and proceed with the operations as required.

To implement secure recovery techniques according to the present disclosure, the CE 300 is configured to implement distribution of recovery shares and updates during member (e.g., PP) addition and deletion as follows. For example, the CTEE 316 calculates/obtains shares sᵢ of the master key for each party i in accordance with the consensus mechanism of the CTEE 316. In examples where the recovery capability is not initialized by default, to initialize the recovery capability, one of the PPs can initiate a request. Once the proposal is approved by a quorum of the PPs, the CTEE 316 generates the key shares as described above and transitions to a state indicating that key retrieval is pending (e.g., a KEY_RETRIEVAL_PENDING state). In this state, the shares sᵢ are distributed to each party by the CTEE 316. In examples where the CTEE 316 cannot push results to the PPs, each party may request the key share. The CTEE 316 can remain in the pending state until each party has retrieved the keys. The key retrieval pending state may be a blocking state (e.g., a state in which no other operations can be initiated until the shares of the key have been distributed to the PPs). Upon distribution of the shares of the master key, the CTEE 316 removes the shares and master key from memory (i.e., memory/storage associated with the CTEE 316, such as internal memory of the CTEE 316). Only sub-keys such as the state key, cluster key, or other key described herein required for writing to persistent storage are maintained in memory of the CTEE 316.

With the recovery capability active, after the addition of a new party or removal of an existing party is approved by quorum, update to the recovery key proceeds as follows in one example process:
The CTEE generates a new master key

$${K}_{m}^{CTEE - new}$$

by querying the random number generator;
The state and cluster keys

$${K}_{s}^{CTEE} , {K}_{C}^{CTEE}$$

are encrypted with the new master key and the relevant section in persistent storage is overwritten with the new data;
Based on the required consensus mechanism, new shares of the master key are computed for the updated list of PPs;
The CTEE enters into a pending state (e.g., a KEY_RETRIEVAL_PENDING state); and
The updated shares are either pushed to each of the PPs or retrieved by each of the PPs by querying the recovery module 322-2. The shares of the original master key can be discarded/deleted by the participants.

In some embodiments, the MOCE master key

$${K}_{m}^{MOCE}$$

can be shared with the PPs instead of being stored in the CTEE 316 as follows:

After initialization of the MOCE 304 and receiving the master key, the CTEE creates shares of the key using based on a pre-configured consensus requirement for key reconstruction. In some examples, the consensus requirement may be the same as that required for the CTEE master key;
The scrambled key,

$$( e . g . , H ( {K}_{s}^{MOCE} ) ,$$

where H(⋅) is a cryptographic hash function) is stored in the CTEE 316 along with consensus requirements/strategy;
The key shares are distributed to each PP; and
To recover the MOCE 304 upon failure, the CTEE 316 performs steps as described above with respect to recovery of the MOCE 304, but with the following modifications:
Upon triggering of MOCE recovery from one of the PPs, the required quorum of PPs examine the proposal/request and vote to accept or reject the proposal. Respective shares of the MOCE master key of parties accepting the proposal are provided to the CTEE 316; and
The CTEE 316 reads the consensus strategy for the MOCE master key from persistent storage and reconstructs the master key from the shares received from the PPs. The scrambled value (e.g. a hashed value) of the master key is verified against the stored value.

Once the master key has been successfully reconstructed, the CTEE 316 can proceed to recover the MOCE 304 as described above.

In some examples, key updates can be performed for a quorum of the PPs. For example, in a case where the consensus mechanism, and hence the key reconstruction, requires all PPs to agree, for a master key K, the initial shares for each party can be calculated by:
Calculating the shares of the key for the first n−1 parties, (e.g., s₁, s₂, . . . , sₙ₋₁) by querying the random number generator for a bit string in length equal to the key; and
Calculating the final share as sₙ=K⊕s₁⊕s₂ ⊕ . . . ⊕sₙ₋₁.

In this example, after distribution, the CTEE 316 can maintain the master key K in memory.

In response to a new participant being added:
A new master key K′ is created;
The share for the new party is calculated as sₙ₊₁=K⊕K′; and
The share for the new party is distributed only to the new party. The shares for the remainder of the PPs remain the same.

If a participant is removed from the approved participants, the following steps occur,
A new master key K′ is created;
The share of the party being removed is requested from the party (e.g., sᵣ);
A delta share (i.e., the change to a share based on the removal of a PP) of a single party is calculated as Δs=K⊕K′⊕sᵣ;
The delta share is sent to the party providing the final approval in the consensus process for the proposal to remove the PP, with the attribute that the share is a delta share;
The receiving party updates a corresponding local share as

$${s}_{k}^{′} = {s}_{k} ⊕ Δ s ;$$

and

The shares for remainder of the parties remain unchanged.

In cases where the share of the party being removed is not available, new shares are computed for all parties and re-distributed (i.e., in the same manner as the generation of the initial master key).

In another embodiment, instead of storing the master key K, the CTEE selects a random share sᵢ from the n−1 shares, and stores it. In case of addition of a new party, a new master key K′ is created, and share for the new party is calculated as sₙ₊₁=sⱼ⊕K′.

In case of removal of a party, the share sᵣ is requested from the party being removed, a new master key K′ is created and a delta share is computed as Δs=sⱼ⊕K′⊕sᵣ and sent to the party providing the final approval in the consensus process with the attribute that the share is a delta share.

In some examples, key shares can be updated locally using a cryptographic hash function or Key Derivative Function (KDF). For example, the shares of each of the PPs can be updated locally (i.e., by the respective PP) by:
Generating, at the CTEE 316, a seed for generation of the shares as r_{seed}. The CTEE 316 generates the shares based on a cryptographic key derivative function (KDF) and the seed;
Generating the share for the first n parties as sᵢ=KDF(r_{seed},i); and
Calculating the master key as K=s₁⊕s₂⊕ . . . ⊕sₙ.

In this example, after distribution of the shares, the CTEE 316 maintains the seed used for generation in memory. The CTEE 316 further maintains a count c for a number of times the master key has been updated.

In response to approving, via consensus, addition of a new PP, the new shares can be calculated by:
Updating the count c by 1;
Calculating the share for the new PP as sₙ₊₁=H^{c}(KDF(r_{seed},n+1)). Here H(⋅) denotes a cryptographic hash function truncated or expanded such that the output length is equal to the key length, and H^{c}(x) represents an invocation of the hash function c times. i.e., H^{c}(x)=H(H . . . c times . . . (H(x));
Deriving/calculating the new key master key as K′=H^{c}(KDF(r_{seed},1))⊕H^{c}(KDF(r_{seed},2))⊕ . . . ⊕H^{c}(KDF(r_{seed},n+1));
Distributing the share sₙ₊₁ to the new PP; and
Updating, at each PP, the PP shares as

$${s}_{i}^{′} = H ( {s}_{i} )$$

(e.g., by computing a hash of the function).

In response to approving, via consensus, removal of a PP, the new shares can be calculated by:
Updating the count c by 1;
Maintaining an order number assigned to the removed PP in a list by the CTEE 316;
Deriving/calculating the new key master key as K′=H^{c}(KDF(r_{seed},1))⊕H^{c}(KDF(r_{seed},2))⊕ . . . ⊕H^{c}(KDF(r_{seed},n)). The number of the removed PP is not used in the calculation of the new key; and
Updating, at each PP, the PP shares as

$${s}_{i}^{′} = H ( {s}_{i} )$$

(e.g., by calculating a hash of the function).

In some examples, to simplify the key update process, a key share of the master key can be distributed to the HP. In these examples, PP updates (i.e., additions or removals) may not require any changes in the key shares of the respective PPs. However, addition of the HP may require a modification of the calculation of the key shares. For example, in cases where consensus of all PPs for recovery is required, if there are n participating parties, the key K is distributed as follows:

Obtain n random strings of length equal to the key length, i.e. s₁, s₂, . . . , sₙ; and
Calculate the share of the hosting party as sₕₚ=K⊕s₁⊕ . . . ⊕sₙ.

Similarly, in cases where consensus of t out of n PPs is required, the shares are can be calculated (e.g., using Shamir secret sharing) over n+1 parties (e.g., assuming that the consensus requirement is t+1 out of n+1). In this example, the threshold for approval does not change since the hosting party can be assumed to always be available.

Addition of a new PP can be performed as described above in the process for performing key updates. Conversely, removal of a PP can be performed by:
Creating a new master key K′;
Requesting the share of the party being removed (e.g., sᵣ);
Calculating the delta share of a single party as, Δs=K⊕K′⊕sᵣ;
Providing the delta share the host provider. The HP updates a corresponding local share as

$${s}_{hp}^{′} = {s}_{hp} ⊕ Δ s ;$$

and
Maintaining the same, unchanged shares for the remaining PPs (i.e., the shares of the remaining PPs remain unchanged.

In cases where the share of the PP being removed is not available, new shares can be calculated for all parties and re-distributed (i.e., in the same manner as the generation of the initial master key).

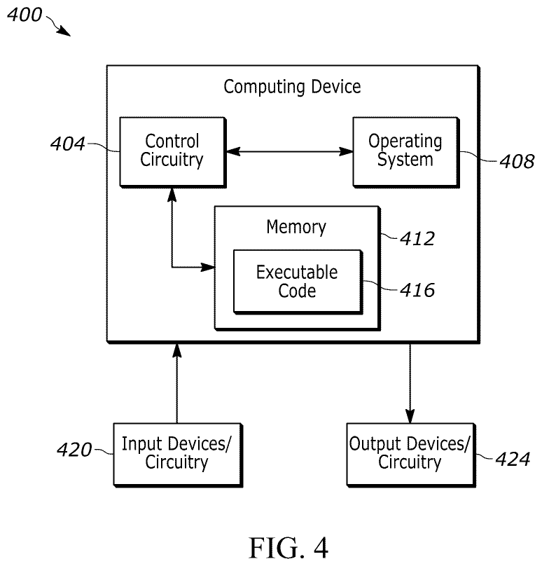

FIG. 4 shows a block diagram of an example computing device 400 configured to implement functions of the systems and methods described herein according to the present disclosure. For example, one or more of the computing devices 400 may implement or be implemented by the one or more components of the CE 300. Systems described herein may implement a single computing device, a plurality of computing devices, etc., configured to individually and/or collectively perform functions related to the systems and methods of the present disclosure. In an example, the CTEE 316 and/or the MOCE/computing system 304 may implement or include one or more of the computing devices 400.

The computing device 400 may include control circuitry 404 that may be, for example, one or more processors or processing devices, a central processing unit processor (a, CPU, such as a CPU configured to operate a protected memory space in accordance with a TEE), an integrated circuit or any suitable computing or computational device, an operating system 408, a memory 412, executable code 416, input devices or circuitry 420, and output devices or circuitry 424. The control circuitry 404 (or one or more controllers or processors, possibly across multiple units or devices) may be configured to implement functions of the systems and methods described herein. More than one of the computing devices 400 may be included in, and one or more of the computing devices 400 may act as the components of, a system according to embodiments of the disclosure. Various components of the computing device 400 may be implemented with same or different circuitry, same or different processors or processing devices, etc.

The operating system 408 may be or may include any code segment (e.g., one similar to the executable code 416 described herein) designed and/or configured to perform tasks involving coordination, scheduling, arbitration, supervising, controlling or otherwise managing operation of the control circuitry 404 (e.g., scheduling execution of software programs or tasks or enabling software programs or other hardware modules or units to communicate). The operating system 408 may be a commercial operating system. The operating system 408 may be an optional component (e.g., in some embodiments, a system may include a computing device that does not require or include the operating system 408). For example, a computer system may be, or may include, a microcontroller, an application specific circuit (ASIC), a field programmable array (FPGA), network controller (e.g., CAN bus controller), associated transceiver, system on a chip (SOC), and/or any combination thereof that may be used without an operating system.

The memory 412 may be or may include, for example, Random Access Memory (RAM), read only memory (ROM), Dynamic RAM (DRAM), Synchronous DRAM (SD-RAM), a double data rate (DDR) memory chip, Flash memory, volatile memory, non-volatile memory, cache memory, a buffer, a short-term memory unit, a long-term memory unit, or other suitable memory units or storage units. The memory 412 may be or may include a plurality of memory units, which may correspond to same or different types of memory or memory circuitry. The memory 412 may be a computer or processor non-transitory readable medium, or a computer non-transitory storage medium, e.g., RAM.

The executable code 416 may be any executable code, e.g., an application, a program, a process, task, or script. The executable code 416 may be executed by the control circuitry 404, possibly under control of the operating system 408. Although, for the sake of clarity, a single item of the executable code 416 is shown, a system according to some embodiments of the disclosure may include a plurality of executable code segments similar to the executable code 416 that may be loaded into the memory 412 and cause the control circuitry 404 to carry out methods described herein. Where applicable, the terms “process” and “executable code” may be used interchangeably herein. For example, verification, validation and/or authentication of a process may mean verification, validation and/or authentication of executable code.

In some examples, the memory 412 may include non-volatile memory having the storage capacity of a storage system. In other examples, the computing device 400 may include or communicate with a storage system and/or database. Such a storage system may include, for example, flash memory, memory that is internal to, or embedded in, a micro controller or chip, a hard disk drive, a solid-state drive, a CD-Recordable (CD-R) drive, a Blu-ray disk (BD), a universal serial bus (USB) device or other suitable removable and/or fixed storage unit. Content may be stored in the storage system and loaded from the storage system into the memory 412 where it may be processed by the control circuitry 404.

The input circuitry 420 may be or may include any suitable input devices, components, or systems, e.g., physical sensors such as accelerometers, thermometers, microphones, analog to digital converters, etc., a detachable keyboard or keypad, a mouse, etc. The output circuitry 424 may include one or more (possibly detachable) displays or monitors, motors, servo motors, speakers and/or any other suitable output devices. Any applicable input/output (I/O) devices may be connected to the control circuitry 404. For example, a wired or wireless network interface card (NIC), a universal serial bus (USB) device, or external storage device may be included in the input circuitry 420 and/or the output circuitry 424. It will be recognized that any suitable number of input devices and output devices may be operatively connected to the control circuitry 404. For example, the input circuitry 420 and the output circuitry 424 may be used by a technician or engineer in order to connect to the control circuitry 404, update software, and the like.

Embodiments may include an article such as a computer or processor non-transitory readable medium, or a computer or processor non-transitory storage medium, such as for example memory, a disk drive, or USB flash memory, encoding, including or storing instructions (e.g., computer-executable instructions, which, when executed by a processor or controller, carry out methods disclosed herein), a storage medium such as the memory 412, computer-executable instructions such as the executable code 416, and a controller such as the control circuitry 404.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments of the disclosure may include components such as, but not limited to, a plurality of central processing units (CPU) or any other suitable multi-purpose or specific processors or controllers (e.g., controllers similar to the control circuitry 404), a plurality of input units, a plurality of output units, a plurality of memory units, and a plurality of storage units, etc. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of CPUs embedded in an on-board system or network, a plurality of chips, FPGAs or SOCs, microprocessors, transceivers, microcontrollers, a plurality of computer or network devices, any other suitable computing device, and/or any combination thereof. For example, a system as described herein may include one or more devices such as the control circuitry 404.

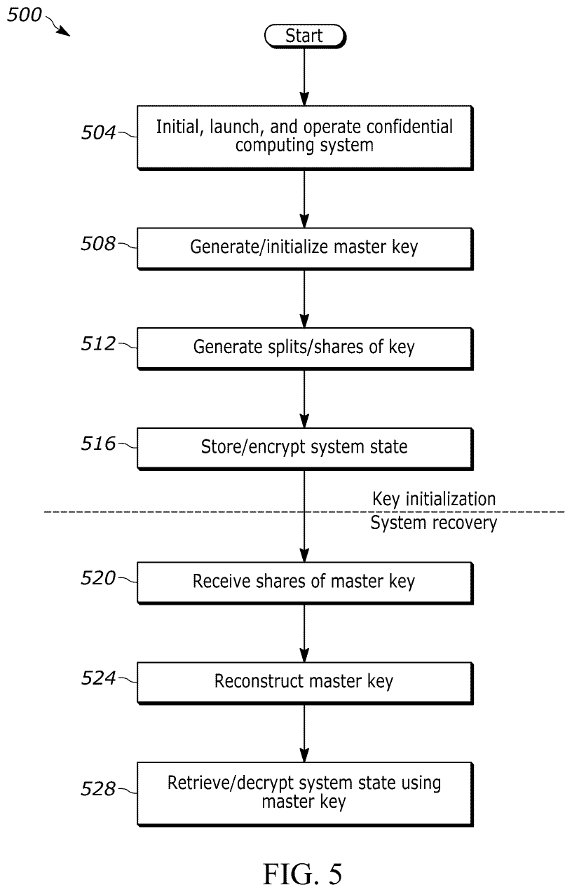

FIG. 5 illustrates steps of an example method 500 for performing secure recovery (e.g., a consensus-based recovery mechanism) in a confidential, cooperative computing environment according to the principles of the present disclosure. For example, one or more computing devices, processors or processing devices, etc. are configured to execute instructions to implement the method 500, such as one or more of processors of the systems described herein. In an example, the CE 300 (e.g., the MOCE 304, the CTEE 316, etc.) implements all or portions of the method 500. As described below, the steps of the method 500 correspond to recovery of a state of an CTEE, although similar steps may be performed for recovery of an MOCE as described above.

At 504, the method 500 includes initiating and operating a confidential computing environment/system to facilitate cooperative computing. For example, a TEE is launched on a confidential computing system, an interface (e.g., an API, CMI, etc. as described herein) is executed to provide access for management functionality to PPs (e.g., via a management gateway), a setup process is initiated, assessed, and approved by PPs, and a build process is launched to being operation of a confidential computing system (e.g., a managed cluster/MOCE).

At 508, the method 500 includes (e.g., during or subsequent to initiating the MOCE at 504) generating/initializing one or more master keys. The master keys may include a CTEE master key, an MOCE master key, etc. The master keys may be referred to as master recovery keys. As described with respect to the method 504, the master key corresponds to a CTEE master key, but similar steps/functions may be performed for an MOCE master key. As one example, a recovery module of the CTEE generates the CTEE master key.

At 512, the method 500 includes generating shares of (i.e., splitting) the CTEE master key for respective PPs associated with the MOCE and providing the shares to the respective PPs.

At 516, the method 500 includes encrypting and storing a system state of the CTEE. For example, the system state is encrypted using a state encryption key, which in turn can be encrypted, at the CTEE, using the CTEE master key. The encrypted system state may be stored outside the CTEE, in persistent storage associated with the CTEE (e.g., a block storage module as described herein), etc.

At 520, the method 500 includes, as part of a secure recovery process, receiving the shares of the CTEE master key from the respective PPs. For example, prior to receiving the shares from the PPs, the CTEE initiates the recovery process (e.g., upon detecting a failure of the CTEE) by providing a request/proposal to the PPs and the PPs vote to approve the proposal. Affirmative votes are provided, along with the respective shares of the CTEE master key, from the PPs to the CTEE.

At 524, the method 500 includes reconstructing, at the CTEE, the CTEE master key using the shares provided by the PPs. At 528, the method 500 includes retrieving and decrypting the stored system state of the CTEE using the CTEE master key. For example, decrypting the stored system state may include using the CTEE master key to decrypt the state encryption key and using the state encryption key to decrypt the stored system state. The CTEE can then continue to operate in accordance with the retrieved/recovered system state.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The various steps and logic performed herein can be executed with non-volatile storage, memory, and processors. Non-volatile storage may include one or more persistent data storage devices such as a hard drive, optical drive, tape drive, non-volatile solid-state device, cloud storage or any other device configured to persistently store information. Processor may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. Memory may include a single memory device or a number of memory devices including, but not limited to, random access memory (RAM), volatile memory, non-volatile memory, static random access memory (SRAM), dynamic random access memory (DRAM), flash memory, cache memory, or any other device configured to store information.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrases “at least one of A, B, and C” and “at least one of A, B, or C” should be construed to mean a logical (A OR B OR C), using a non-exclusive logical OR, and should not be construed to mean “at least one of A, at least one of B, and at least one of C.”

The terms “a,” “an,” “the,” and “said” as used herein in connection with any type of processing component configured to perform various functions may refer to one processing component configured to perform each and every function, or a plurality of processing components collectively configured to perform each of the various functions. By way of example, “A processor” configured to perform actions A, B, and C may refer to one or more processors configured to perform actions A, B, and C. In addition, “a processor” (or, “a processing device,” “a computing device,” and so on) configured to perform actions A, B, and C may also refer to a first processor configured to perform actions A and B, and a second processor configured to perform action C. Further, “A processor” configured to perform actions A, B, and C may also refer to a first processor configured to perform action A, a second processor configured to perform action B, and a third processor configured to perform action C.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

What is claimed is:

1. A method for performing secure recovery for a multi-owned computing environment (MOCE), the method comprising, using one or more computing devices:
establishing a confidential computing system using a trusted execution environment (TEE) associated with a plurality of participating parties (PPs), the confidential computing system including the MOCE;
executing, on the confidential computing system, a controller in the TEE (CTEE);
using the CTEE to generate a master key;
generating respective master key shares corresponding to respective PPs of the plurality of PPs and providing the respective master key shares to the respective PPs;
using the CTEE to generate a second key;
encrypting a system state corresponding to at least one of the CTEE and the MOCE with the second key and storing the system state on an external system;
encrypting the second key with the master key and storing the second key on the external system; and
using the respective master key shares to reconstruct the master key and recovering the system state using the reconstructed master key.

2. The method of claim 1, further comprising recovering the confidential computing system by:
executing, using the CTEE, an interface configured to provide, to the plurality of PPs, the ability to initiate and vote on a proposed action;
receiving, via the interface from a requesting PP of the plurality of PPs, a request to initiate recovery of at least the CTEE or the MOCE; and
receiving, via the interface from one or more PP of the plurality of PPs, an agreement to recover at least one of the CTEE and the MOCE and the respective master key shares of the master key;
in response to a determination that the plurality of PPs approved the request, using the respective master key shares to reconstruct the master key;
decrypting, with the master key, the system state on the external system; and
recovering at least one of the CTEE and MOCE using the decrypted system state.

3. The method of claim 1, wherein storing the system state includes:
using the CTEE to generate a second key;
using the MOCE to generate a third key;
storing, on the external system, the state of the MOCE encrypted using the third key;
storing, on the external system, the third key encrypted using the second key;
storing, on the external system, the state of the CTEE encrypted using the second key;
storing, on the external system, the second key encrypted using the master key; and
generating respective master key shares corresponding to the respective PPs of the plurality of PPs and providing the respective master key shares to the respective PPs.

4. The method of claim 3, further comprising distributing the respective master key shares to the plurality of PPs by generating respective key shares of the third key in the MOCE corresponding to the respective PPs of the plurality of PPs and providing the respective key shares of the third key to the respective PPs.

5. The method of claim 3, wherein, after every fixed time interval, a state of at least one of the CTEE and the MOCE is encrypted using at least one of the master key, the second key, and the third key; and
the encrypted state is stored on one or more external systems.

6. The method of claim 3, wherein, after every new action triggered by one or more PP of the plurality of PPs, a state of at least one of the CTEE and the MOCE is encrypted using at least one of the master key, the second key, and the third key; and
the encrypted state is stored on one or more external systems.

7. The method of claim 1, further comprising:
monitoring, by a hosting party (HP), a state of the CTEE;
in response to detection of failure of the CTEE, launching, by the HP, a second confidential computing environment with a second CTEE;
setting or resetting a recovery possible flag by checking availability of an encrypted system state on the external system; and
in response to receiving, via an interface from one or more PP of the plurality of PPs, an agreement to recover the CTEE and the respective shares of the master key and recovering the CTEE using the encrypted system state.

8. The method of claim 1, wherein the method includes:
monitoring, by the CTEE, a state of the MOCE;
in response to detection of failure of MOCE, launching, by the CTEE, a second confidential computing environment with a second MOCE;
setting or resetting an MOCE recovery possible flag by checking availability of an encrypted system state on the external system; and
in response to receiving, via the interface from one or more PP of the plurality of PPs, an agreement to recover the MOCE and the share of the master key and recovering the MOCE using the encrypted system state.

9. The method of claim 1, further comprising distributing the master key shares by:
on addition or deletion of a PP to the plurality of PPs, generating a new master key by using a random number generator;
storing, on the external system, the second key encrypted using the new master key; and
generating new master key shares for the new master key corresponding to the respective PPs of the plurality of PPs and providing the respective new master key shares to the respective PPs.

10. The method of claim 9, wherein distributing the respective new master key shares for addition of a new PP includes:
generating, using a random number generator, the new master key;
for each bit of the new master key, computing a modulo two addition (binary XOR) with the master key; and
distributing, to the new PP as a share of the new master key, a result of the modulo two addition.

11. The method of claim 9, wherein distributing the new master key shares for deletion of a first PP includes:
generating, using a random number generator, the new master key;
requesting, from the first PP, a first respective share of the master key;
selecting a second PP and requesting, from the second PP, a second respective share of the master key;
for each bit of the new master key, computing a modulo two addition (binary XOR) with the master key, the first respective share of the first PP, and the second respective share of the second PP; and
distributing, to the second PP as a share of the new master key, a result of the modulo two addition.

12. The method of claim 1, wherein generating and distributing the master key shares includes:
generating, using a random number generator, a random seed;
generating a first share of the master key for a first PP by computing a cryptographic key derivation function over the random seed and a numerical identity of the first PP;
generating each bit of the master key by computing a modulo two addition (binary XOR) of corresponding bits for all PPs in the plurality of PPs; and
providing the respective master key shares to the respective PPs in the plurality of PPs.

13. The method of claim 1, further comprising distributing the master key shares by:
generating a first share of the master key for a hosting party (HP) in addition to the respective master key shares for the respective PPs;
distributing, to the HP, the first share of the master key; and
to recover the master key, requesting, from the plurality of PPs and the HP, the respective shares of the master key, combining the respective master key shares to obtain the master key.

14. The method of claim 1, wherein the system state stored on the external system includes a list of the plurality of PPs and integrity validation data comprising a cryptographically signed digest of the list.

15. A system configured to perform secure recovery for a multi-owned computing environment (MOCE), the system comprising:
one or more computing devices configured to
establish a confidential computing system using a trusted execution environment (TEE) associated with a plurality of participating parties (PPs), the confidential computing system including the MOCE,
execute, on the confidential computing system, a controller in the TEE (CTEE),
using the CTEE, generate a master key,
generate respective master key shares corresponding to respective PPs of the plurality of PPs and provide the respective master key shares to the respective PPs,
use the CTEE to generate a second key,
encrypt a system state corresponding to at least one of the CTEE and the CTEE with the second key and store the system state on an external system,
encrypt the second key with the master key and storing the second key on the external system, and
using the respective master key shares, reconstruct the master key and recover the system state using the reconstructed master key.

16. The system of claim 15, wherein the one or more computing devices are configured to recover the confidential computing system by:
executing, using the CTEE, an interface configured to provide, to the plurality of PPs, the ability to initiate and vote on a proposed action;
receiving, via the interface from a requesting PP of the plurality of PPs, a request to initiate recovery of at least the CTEE or the MOCE; and
receiving, via the interface from one or more PP of the plurality of PPs, an agreement to recover at least one of the CTEE and the MOCE and the respective master key shares of the master key;
in response to a determination that the plurality of PPs approved the request, using the respective master key shares to reconstruct the master key;
decrypting, with the master key, the system state on the external system; and
recovering at least one of the CTEE and MOCE using the decrypted system state.

17. The system of claim 15, wherein storing the system state includes:
using the CTEE to generate a second key;
using the MOCE to generate a third key;
storing, on the external system, the state of the MOCE encrypted using the third key;
storing, on the external system, the third key encrypted using the second key;
storing, on the external system, the state of the CTEE encrypted using the second key;
storing, on the external system, the second key encrypted using the master key; and
generating respective master key shares corresponding to the respective PPs of the plurality of PPs and providing the respective master key shares to the respective PPs.

18. The system of claim 17, wherein the one or more computing devices are further configured to distribute the respective master key shares to the plurality of PPs by generating respective key shares of the third key in the MOCE corresponding to the respective PPs of the plurality of PPs and providing the respective key shares of the third key to the respective PPs.

19. The system of claim 17, wherein, after every fixed time interval, a state of at least one of the CTEE and the MOCE is encrypted using at least one of the master key, the second key, and the third key; and
the encrypted state is stored on one or more external systems.

20. The system of claim 17, wherein, after every new action triggered by one or more PP of the plurality of PPs, a state of at least one of the CTEE and the MOCE is encrypted using at least one of the master key, the second key, and the third key; and
the encrypted state is stored on one or more external systems.
